(19) United States
(12) Patent Application Publication
(10) Pub. No.: US 2017/0316415 A1
(43) Pub. Date: Nov. 2, 2017

(54) SYSTEMS AND METHODS FOR EXTRACTING BROWSER-OBTAINED DEVICE INFORMATION FOR AUTHENTICATING USER DEVICES

(71) Applicant: MasterCard International Incorporated, Purchase, NY (US)

(72) Inventors: Patricia Gonzalez, Dublin (IE); Mikel Cordovilla Mesonero, Dublin (IE)

(21) Appl. No.: 15/143,006

(22) Filed: Apr. 29, 2016

(51) Int. Cl. G06Q 20/40

(52) U.S. Cl. CPC G06Q 20/409

(57) ABSTRACT

A device authentication computing device for authenticating consumer computing devices used to perform online payment transactions is provided. The device authentication computing device receives cardholder device information for each of a plurality of cardholder computing devices of a cardholder and stores the cardholder device information based on a unique identifier associated with the cardholder. During an online transaction using a consumer computing device, the device authentication computing device receives an authentication request message and a unique identifier associated with the cardholder. The device authentication computing device also receives, via an Internet browser, transaction device information corresponding to the consumer computing device. The device authentication computing device compares the device information received during the transaction to the stored cardholder device information. Based on the comparison, the device authentication computing device transmits an authentication response message to the merchant indicating whether the transaction device information matches stored cardholder device information.

### BACKGROUND

The field of the disclosure relates generally to fraud detection and, more particularly, to network-based systems and methods for authenticating user computing devices used in online payment transactions.

Parties to online payment transactions, which may include cardholders, merchants, payment processors, issuer banks, and acquirer banks, have an interest in reducing the harm posed by fraudulent cardholder activity. Accordingly, such parties may analyze data obtained in conjunction with a payment transaction to identify potentially fraudulent activity.

One type of fraudulent activity occurs when a person fraudulently poses as a cardholder to make online purchases. For example, the person may provide personal and payment card information of the cardholder during the course of the transaction without the cardholder's permission or knowledge. Known systems attempt to detect this type of fraudulent activity but are ultimately limited in their effectiveness.

A computing device may include an Internet browser that allows the computing device to navigate the Internet. Such browsers may capture data and may cause the computing device to send the data to a server or other computing device. In the case of online payment transactions, for example, the Internet browser may capture data when the computing device accesses a web site associated with the merchant that is then transmitted by the computing device to the merchant, a web host corresponding to the merchant, or other parties involved in the process, such as a payment processor.

### BRIEF DESCRIPTION OF THE DISCLOSURE

In one aspect, a device authentication computing device is disclosed. The device authentication computing device includes one or more processors in communication with one or more memory devices and is configured to: receive cardholder device information for each of a plurality of cardholder computing devices of a cardholder; store the cardholder device information based on a unique identifier associated with the cardholder; receive an authentication request message requesting that a consumer computing device be authenticated as an authenticatable cardholder computing device; receive, via an Internet browser of the consumer computing device, transaction device information corresponding to the consumer computing device; receive a unique identifier associated with the cardholder; retrieve the stored cardholder device information based on the unique identifier; compare the stored cardholder device information with the transaction device information; and transmit an authentication response message, either directly or indirectly, to the merchant, the authentication response message indicating whether the transaction device information matches the stored cardholder device information.

In a second aspect, a computer-implemented method for authenticating user computing devices during online payment transactions is provided. The method is implemented using a device authentication computing device in communication with one or more memory devices. The method includes: receiving cardholder device information for each of a plurality of cardholder computing devices of a cardholder; storing the cardholder device information based on a unique identifier associated with the cardholder; receiving an authentication request message requesting that a consumer computing device be authenticated as an authenticatable cardholder computing device receiving, via an Internet browser of the consumer computing device, transaction device information corresponding to the consumer computing device; receiving a unique identifier associated with the cardholder; retrieving the stored cardholder device information based on the unique identifier; comparing the stored cardholder device information with the transaction device information; and transmitting an authentication response message, either directly or indirectly, to the merchant, the authentication response message indicating whether the transaction device information matches the stored cardholder device information.

In yet another aspect, a computer-readable storage medium having computer-executable instructions embodied thereon is provided. When executed by a device authentication computing device having one or more processors in communication with one or more memory devices, the computer-executable instructions cause the fraud detection computing device to: receive cardholder device information for each of a plurality of cardholder computing devices of a cardholder; store the cardholder device information based on a unique identifier associated with the cardholder; receive an authentication request message requesting that a consumer computing device be authenticated as an authenticatable cardholder computing device receive, via an Internet browser of the consumer computing device, transaction device information corresponding to the consumer computing device; receive a unique identifier associated with the cardholder; retrieve the stored cardholder device information based on the unique identifier; compare the stored cardholder device information with the transaction device information; and transmit an authentication response message, either directly or indirectly, to the merchant, the authentication response message indicating whether the transaction device information matches the stored cardholder device information.

### BRIEF DESCRIPTION OF THE DRAWINGS

FIGS. 1-7B show example embodiments of the methods and systems described herein.

FIG. 1 is a schematic diagram illustrating a payment platform having a device authentication computing device.

FIG. 2 is a diagram illustrating a device authentication system including the device authentication computing device shown in FIG. 1, in communication with the payment processing system of FIG. 1.

FIG. 3 is a diagram illustrating an example of the device authentication computing shown in FIGS. 1 and 2.

FIG. 4 is a diagram illustrating an example of a user computing device that may be used by a user, such as the cardholder as shown in FIG. 2.

FIG. 5 is an illustration of a storage system for storing cardholder device information in accordance with one example embodiment of the present disclosure.

FIG. 6 is a flow chart illustrating an example method for validating online payment transactions using the device authentication computing device shown in FIGS. 1 and 2 in accordance with one example embodiment of the present disclosure.

FIGS. 7A and 7B depict a flow chart illustrating an example method for maintaining and updating a storage system for storing cardholder device information in accordance with one example embodiment of the present disclosure.

### DETAILED DESCRIPTION OF THE DISCLOSURE

The field of the disclosure relates generally to online fraud detection and, more particularly, to network-based systems and methods for authenticating user computing devices for online payment transactions.

In systems and methods described herein, transaction device information collected during an online payment transaction is compared to previously collected and verified device information to authenticate a user computing device. If the user computing device is not authenticated, remedial measures such as declining the transaction, notifying the cardholder of potential fraud, and the like, may be initiated.

For clarity, the term “user computing device” is intended to refer to any computing device that may be used to complete an online payment transaction. The terms “consumer computing device” and “candidate cardholder computing device” are used to denote unauthenticated user computing devices, i.e., user computing devices for which it is unknown whether the user computing device corresponds to a known user computing device of a cardholder. In contrast, the term “cardholder computing device” is used to denote a user computing device known to be associated with a cardholder. Accordingly, an online payment transaction is generally described herein as being conducted with a consumer computing device. The consumer computing device may then be authenticated by comparing device information of the consumer computing device, generally referred to herein as “transaction device information”, with that of one or more cardholder computing devices.

Many cardholders perform online payment card transactions using a plurality of cardholder computing devices. For example, a single cardholder may own and conduct online payment transactions using any two or more of a mobile phone, a laptop, a desktop, a tablet, and the like. To account for the possibility that a cardholder may make transactions on multiple cardholder computing devices, systems and methods described herein may store device information corresponding to one or more known cardholder computing devices. In certain embodiments, the stored device information is stored based on a primary account number or similar unique identifier associated with the cardholder. Each such identifier may be further associated with one or more instances of data structures corresponding to cardholder computing devices. Each cardholder computing device data structure may further contain a collection of device information obtained from the respective cardholder computing device. Accordingly, when a primary account number is submitted by a consumer computing device during the course of an online payment transaction, the primary account number may be used to retrieve the corresponding cardholder device information. Authentication may then be performed by determining whether the transaction device information obtained from the consumer computing device substantially conforms to or matches the stored device information corresponding to a cardholder computing device associated with the primary account number.

Cardholder computing device information may change over time. For example, software or firmware on a cardholder computing device may be updated. Similarly, a cardholder may obtain a new cardholder computing device or stop using a previously owned cardholder computing device. To account for these changes, systems and methods described herein enable updating of the device information stored in a cardholder's set of cardholder computing devices. Updates may include, but are not limited to, changes to pieces of device information or adding, removing, or replacing cardholder computing devices from the set.

Performing authentication based on a collection of device information corresponding to a set of cardholder devices improves the accuracy and reliability of fraud detection measures. For example, by accounting for the possibility that a cardholder may make online payment transactions using multiple cardholder computing devices, embodiments of this disclosure reduce the possibility that an online payment transaction will be incorrectly identified as fraudulent. Entities throughout the payment processing chain benefit from the reduction of such false fraud alerts. Cardholders and merchants, for example, are less likely to have legitimate online payment transactions rejected or delayed. Payment processors, acquiring banks, and issuing banks are also less likely to waste time and money resolving false fraud alerts. A fraud alert may, for example, trigger retrieval and transmission of data such as account details, purchase histories, and the like. Reducing the possibility of false fraud alerts reduces the likelihood that such data will be sent erroneously, improving overall performance of the payment processing network by eliminating unnecessary network traffic.

Systems and methods described herein use stored device information corresponding to known sets of cardholder devices to improve the reliability with which fraudulent online cardholder activity may be detected. The methods and systems described herein may be implemented using computer programming or engineering techniques including computer software, firmware, hardware or any combination or subset thereof, to perform at least one of the following steps: (1) receiving cardholder device information for each of a plurality of cardholder computing devices of a cardholder; (2) storing the cardholder device information based on a unique identifier associated with the cardholder; (3) receiving an authentication request message requesting that a consumer computing device be authenticated as an authenticatable cardholder computing device; (4) receiving, via an Internet browser of the consumer computing device, transaction device information corresponding to the consumer computing device; (5) receiving a unique identifier associated with a consumer of the consumer computing device; (6) retrieving the stored cardholder device information based on the unique identifier; (7) comparing the stored cardholder device information with the transaction device information; and (8) transmitting an authentication response message, either directly or indirectly, to the merchant, the authentication response message indicating whether the transaction device information matches the stored cardholder device information.

By performing these steps, the systems and methods disclosed herein solve problems in computer networking (and specifically in financial networking) related to online fraud detection that would otherwise be unattainable. More specifically, by retrieving, maintaining, and analyzing collections of stored device information for sets of cardholder computing devices and using the stored device information as a means for authenticating consumer computing devices, systems and methods according to this disclosure solve a problem necessarily rooted in computer networking. Further, by retrieving, maintaining, and analyzing collections of device information for sets of cardholder computing devices, the systems and methods described herein are configured to leverage the stored device information to improve the overall performance of a financial network through improved fraud detection.

To establish the set of cardholder computing devices, a cardholder may register one or more cardholder computing devices. Registration generally refers to the process of acquiring device information for a cardholder computing device and storing the device information in the set of cardholder computing devices associated with the cardholder. Generally, the cardholder device information is extracted from the cardholder computing device via an Internet browser. Available device information varies from device-to-device and Internet browser-to-Internet browser, but the device information may generally include information regarding the Internet browser itself and software, firmware, hardware, settings, and the like of the user computing device on which the Internet browser is running.

In certain embodiments, a cardholder may use an Internet browser of a cardholder computing device to navigate to a website of one of a payment processor, a merchant, and an issuing bank. To register the cardholder computing device, the website may request that the cardholder verify his or her identity by providing a password, answering security questions, confirming previous payments, entering a code sent to the cardholder's email or mobile phone, and the like. After providing adequate verification, the website may cause the cardholder computing device to run a script or other code that captures the cardholder device information via the Internet browser and transmits the cardholder device information to a device authentication computing device for storage. In certain embodiments, registration may occur during the course of an online payment transaction. For example, a cardholder may enter into a payment transaction using a cardholder computing device that is not recognized by a device authentication computing device in accordance with this disclosure. In response, the device authentication computing device may request verifying information. Provided the cardholder provides adequate verification, the device authentication computing device may retrieve device information from the cardholder computing device and add to or update the stored device information corresponding to the cardholder's set of cardholder devices.

During the course of an online payment transaction subsequent to registration, a merchant, a web host associated with the merchant, or another entity, such as a payment processor, may transmit an authentication request message to the device authentication computing device. In addition to or as part of the authentication request message, the device authentication computing device may receive a unique identifier associated with the cardholder whose information is being used for the online payment transaction. Using the unique identifier, the device authentication computing device may retrieve the stored device information corresponding to cardholder computing devices of the cardholder.

In addition to or as part of the authentication request message, the device authentication computing device may also receive transaction data corresponding to the consumer computing device. For purposes of this disclosure, the term “transaction device information” refers to device information obtained from a consumer computing device during the course of an online payment transaction. Transaction device information is generally associated with a user computing device. In contrast, the term “cardholder device information” refers to device information obtained from a known cardholder computing device, for example, during the registration process. The term “stored device information” is intended to refer to cardholder device information that has been stored for later comparison with transaction device information to authenticate user computing devices.

In certain embodiments, transaction device information may be obtained when a user of the consumer computing device uses an Internet browser operating on the consumer computing device to navigate to or otherwise interact with a page of a merchant website, such as a payment page, that includes one or more code snippets. When executed by the consumer computing device, the code snippets may cause the consumer computing device to capture the transaction device information through the Internet browser and to transmit the transaction device information, either directly or indirectly (e.g., through the merchant or a web host associated with the merchant), to the device authentication computing device. For example, the code snippet may be executed in response to a user clicking a button, clicking a link, opening a particular page on the website, adding an item to an electronic shopping cart, or taking any other action on the website.

After the device authentication computing device has received the transaction device information and retrieved the stored cardholder device information, the device authentication computing device generally compares the two sets of device information to determine whether the consumer computing device corresponds to a cardholder computing device associated with the cardholder. Comparison of the transaction device information to the stored cardholder device information is generally conducted on a device-by-device basis. For example, if the stored device information corresponds to a set of cardholder computing devices containing three cardholder computing devices, the transaction device information will be compared to the stored device information for each of the three cardholder devices in turn.

Depending on how closely the two sets of device information math, the device authentication computing device may take various actions. If the transaction device information matches (either exactly or above a predetermined match threshold), the device authentication computing device may authorize the consumer computing device and transmit an authorization message to the merchant, the web host of the merchant, or other parties, such as a payment processor. If the transaction device information does not match the stored device information of any cardholder computing device, the device authentication computing device may deny authorization of the consumer computing device and take various remedial measures including, but not limited to, transmitting a non-authorization message to the merchant, the web host of the merchant, or other parties, such as a payment processor; initiating a registration process for the consumer computing device; declining the transaction; flagging the transaction for additional investigation; issuing a fraud alert; freezing the cardholder's account; and the like. To the extent a consumer computing device is authorized but the stored device information of the most similar cardholder computing device differs from the transaction device information, the device authentication computing device may also update the stored device information of the most similar cardholder computing device to reflect the transaction device information. The device authentication computing device may also add new cardholder computing devices to a cardholder's collection, remove old cardholder computing devices from a cardholder's collection, or replace old cardholder computing devices with new cardholder computing devices as necessary.

### Example of Payment Card Transaction Network

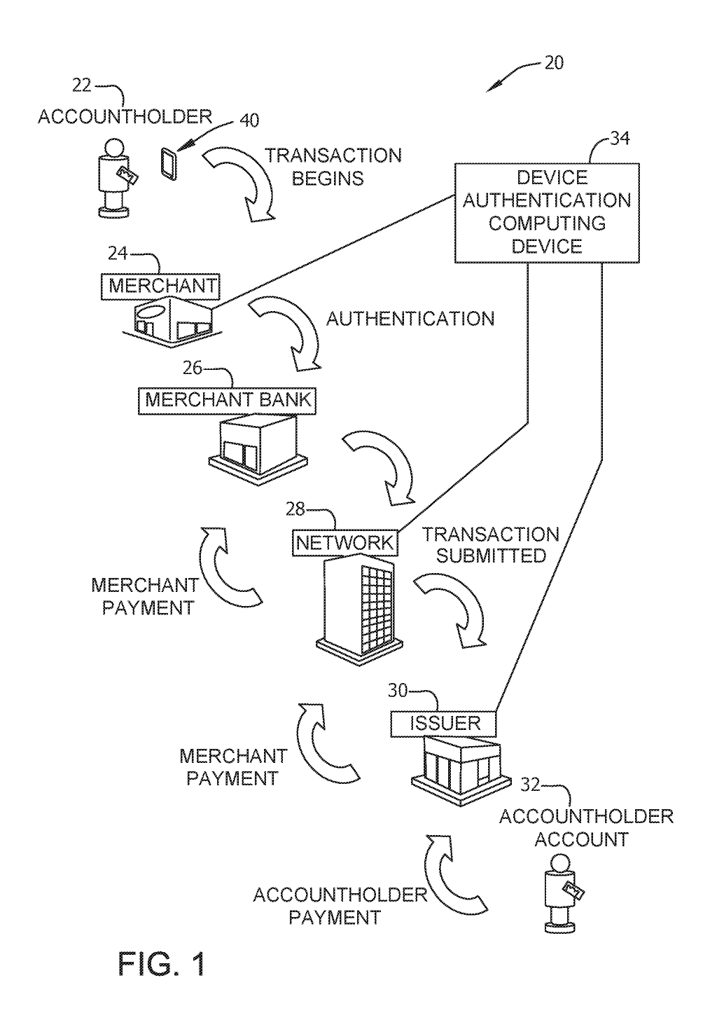

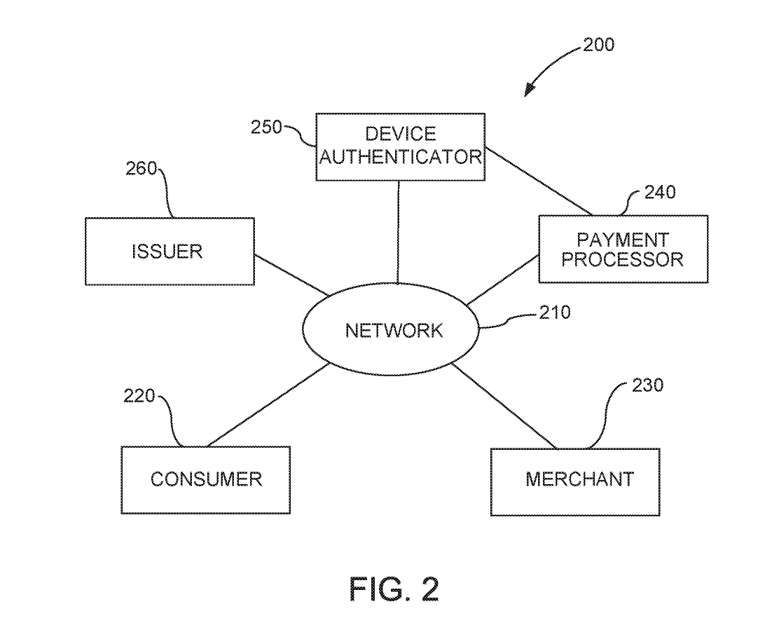

FIG. 1 is a schematic diagram illustrating a payment platform 20 that includes a device authentication computing device 34 and which provides processing services to various financial entities. Embodiments described herein may relate to a transaction card system, such as a payment card payment system using the MasterCard® interchange network. The MasterCard® interchange network is a set of proprietary communications standards promulgated by MasterCard International Incorporated for the exchange of financial transaction data and the settlement of funds between financial institutions that are associated with MasterCard International Incorporated. (MasterCard is a registered trademark of MasterCard International Incorporated located in Purchase, N.Y.).

In a typical transaction card system, a financial institution referred to as the “issuer” issues a transaction card, such as a credit card, debit card, and the like, to the consumer or accountholder 22, who uses the transaction card to tender payment for a purchase from merchant 24. To accept payment with the transaction card, merchant 24 normally establishes an account with a financial institution that is part of the financial payment system. This financial institution is referred to as the “merchant bank,” the “acquiring bank,” or the “acquirer.” In one embodiment, accountholder 22, also referred to as cardholder, tenders payment for a purchase using a transaction card at a transaction processing device 40 (e.g., a point of sale device), and merchant 24 then requests authorization from a merchant bank 26 for the amount of the purchase. The request is usually performed through the use of a point-of-sale terminal, which reads account information from a magnetic stripe, a chip, embossed characters, and the like, included on the transaction card of the accountholder 22 and communicates electronically with the transaction processing computers of merchant bank 26. In the context of transactions with online merchants, an accountholder 22 may provide their account information, such as their account number, a card verification number, an expiration date, and the like through a website. Alternatively, merchant bank 26 may authorize a third party to perform transaction processing on its behalf. In this case, the point-of-sale terminal may be configured to communicate with the third party. Such a third party may be referred to as a “merchant processor,” an “acquiring processor,” or a “third party processor.”

Using an interchange network 28, computers of merchant bank 26 or merchant processor may communicate with computers of an issuer bank 30 to determine whether account 32 of accountholder 22 is in good standing and whether the purchase is covered by an available credit line of the account 32 corresponding to accountholder 22. Based on these determinations, the request for authorization may be declined or accepted. If the request is accepted, an authorization code may be issued to merchant 24.

During a payment card transaction, and particularly on online payment transaction, authentication may be used to reduce the likelihood of fraudulent transactions and to improve the overall security of transactions conducted over the system. Authentication generally refers to the process of verifying that the entity providing payment information during the payment transaction is, in fact, the actual accountholder 22.

Authentication may be accomplished in various ways. For example, in in-person transactions, a merchant may authenticate the transaction by examining a payment card and comparing a name and signature on the payment card to those on a piece of identification, such as a driver's license. In online purchases, authentication may be performed by requesting one or more of a password, an answer to a security question, confirmation of past purchases, and other identifying information. Online purchases may also be authenticated by verifying that the device on which the transaction is being performed corresponds to a known device of the accountholder. For example, a user computing device used in an online purchase transaction may be authenticated by determining the presence and/or contents of a “cookie” or similar token on the user computing device or by comparing attributes of the user computing device to previously obtained values of the same attributes.

In payment platform 20, authentication is performed by a device authentication computing device 34 which may be communicatively coupled to merchant 24. Device authentication computing device 34 may have access to historical device information corresponding to cardholder computing devices of accountholder 22. In certain embodiments, device authentication computing device 34 may create initial device information entries in the historical device information based on device information collected from accountholder 22 during a device registration process. For example, accountholder 22 may navigate to a device registration website using an Internet browser hosted by one or more of merchant 24, network 28, and issuer 30 and provide verifying information such as passwords, answers to security questions, and the like. The registration website may include code snippets or scripts that, when executed by the cardholder computing device, cause the cardholder computing device to retrieve device information from the Internet browser and to transmit the device information, either directly or indirectly through other computing devices, to device authentication computing device 34 for storage. Embodiments of storage systems in accordance with this disclosure specifically permit an accountholder to register multiple cardholder computing devices.

During a subsequent online payment transaction, a consumer, who may or may not be accountholder 22 and may sometimes be referred to as a candidate cardholder, may attempt to complete an online purchase on a merchant website hosted by merchant 24 via an Internet browser operating on a user computing device. In response to the consumer's attempt, merchant 24 may send an authentication request message to device authentication computing device 34. During the course of the online payment transaction, transaction device information may also be capture through the Internet browser and transmitted to device authentication computing device 34 either directly from the user computing device or via merchant 24. One of the authentication request message and the transaction data may include a unique identifier associated with the cardholder whose information the consumer is attempting to use for the purchase. For example, the unique identifier may correspond to a primary account number of the cardholder. Using the unique identifier, device authentication computing device 34 may then retrieve stored device information of the cardholder and compare the transaction device information to the retrieved device information to determine whether the consumer computing device is a match to a registered cardholder device. If a match exists, device authentication computing device 34 may generate and transmit an authentication message to one or more of merchant 24, network 28, and issuer 30 and the online payment transaction may be permitted to proceed. If the user computing device is not sufficiently similar to a registered cardholder computing device the device authentication computing device 34 may take remedial measures such as requesting additional verification from the consumer, generating and transmitting a non-authentication message, or generating and transmitting a fraud alert.

If accountholder 22 is authenticated and a request for authorization is accepted, the available credit line of the accountholder 22 is decreased, that is, account 32 is decreased. A charge for a payment card transaction may not be posted immediately to account 32 of the accountholder 22 because payment networks, such as MasterCard International Incorporated, may have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If accountholder 22 cancels a transaction before it is captured, a “void” is generated. If accountholder 22 returns goods after capture of the transaction, a “chargeback” is generated. Interchange network 28 and/or issuer bank 30 stores the transaction card information, such as a type of merchant, amount of purchase, date of purchase, in a database.

After a purchase has been made, a clearing process occurs to transfer additional transaction data related to the purchase among the parties to the transaction, such as merchant bank 26, interchange network 28, and issuer bank 30. According to various aspects herein, during the clearing process, additional data (i.e., addendum data), may be added to the transaction data. Accordingly, addendum data may be associated with a transaction and transmitted between parties to the transaction as transaction data, and may be stored by any of the parties to the transaction.

After a transaction is authorized and cleared, the transaction may be settled among merchant 24, merchant bank 26, and issuer bank 30. Settlement refers to the transfer of financial data or funds among merchant 24's account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

### Example of a Device Authentication System

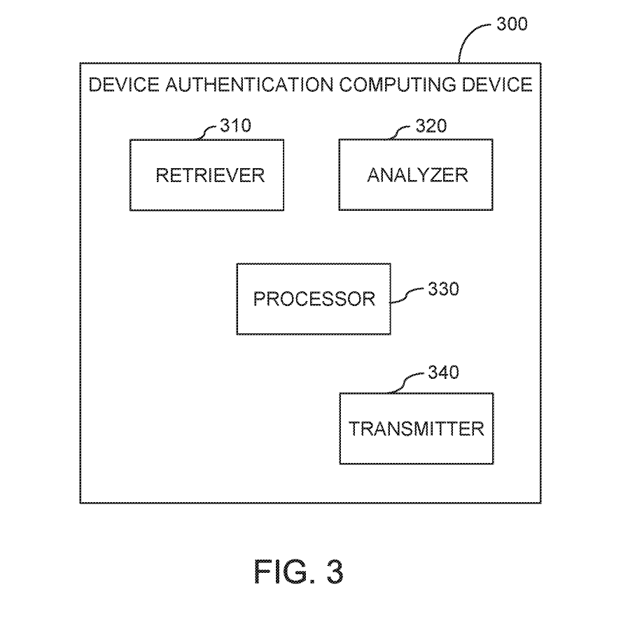

FIG. 2 is a diagram illustrating a device authentication system 200 including a consumer, a merchant, a payment processor, an issuer, and a device authenticator, which may correspond to device authentication computing device 34 (shown in FIG. 1), in accordance with an example embodiment of the present disclosure.

Referring to FIG. 2, device authentication system 200 includes computing devices that respectively represent a consumer 220, a merchant 230, a payment processor 240, a device authenticator 250, and an issuing bank (“issuer”) 260 which are connected to each other via network 210. Network 210 may include the Internet, the interchange network 28 of FIG. 1, and/or one or more other networks. For example, a connection between the computing devices may include a wireless network, a wired network, a telephone network, a cable network, a combination thereof, and the like. Examples of a wireless network include networks such as WiFi, WiMAX, WiBro, local area network, personal area network, metropolitan area network, cellular, Bluetooth, and the like.

Consumer 220 may be a computing device, for example, a mobile phone, a smart phone, a telephone, a computer, a laptop, a desktop, a tablet, an MP3 player, a digital assistant, a server, and the like. Consumer 220 may access a website that corresponds to the merchant 230 or that is hosted by merchant 230, may contact a phone number of merchant 230, and the like. Payment processor 240 may be a processing entity such as MASTERCARD®, VISA®, AMERICAN EXPRESS®, and the like. Issuer 260 may be a third-party bank that issued a payment card to a cardholder. For example, issuer 260 may correspond to payment processor 240.

Device authenticator 250 may permit a cardholder to register multiple cardholder devices with device authenticator 250. Registration generally refers to the process of verifying a cardholder computing device and obtaining and storing cardholder device information (sometimes referred to as the “device fingerprint”) corresponding to the cardholder computing device. As described below in more detail, device authenticator 250 may use the stored device information obtained during registration to authenticate consumer computing devices, such as consumer 220, used to conduct online payment transactions using the cardholder's payment card information. Device authenticator 250 may be coupled to or included within payment processor 240, issuer 260, merchant 230, and the like. As another example, device authenticator 250 may be a separate device connected to one or more of the other computing devices through network 210.

As used herein, the term “consumer” or “candidate cardholder” may be used to refer to a person who initiates a payment card purchase that has not yet been confirmed or authenticated as the actual cardholder. At least as described herein, the consumer or candidate cardholder must be authenticated before being recognized as the actual cardholder. The term “actual cardholder” means a consumer or candidate cardholder that has been verified or authenticated. Once authentication occurs, the consumer or candidate cardholder becomes known as the actual cardholder, the actual cardholder being the person the payment card has been issued to by the issuing bank.

In certain embodiments, a cardholder may navigate to a website of one of a payment processor, a merchant, and an issuing bank using an Internet browser operating on the cardholder computing device to be registered. Registration may generally include verifying the cardholder's identity, obtaining the cardholder device information, and storing the cardholder device information and may be performed in conjunction with device authenticator 250.

Verifying a cardholder's identity may be accomplished by requesting particular information known to or made available to the cardholder. In certain embodiments, the cardholder's identity may be verified by the cardholder providing a password, answering security questions, confirming previous payments, entering a code sent to the cardholder's email or mobile phone, and the like. If the cardholder provides adequate verification of his or her identity, the website may cause the cardholder computing device to execute a script, code snippet, or the like that captures cardholder device information from the Internet browser and transmits the cardholder device information to device authenticator 250 for storage.

In certain embodiments, registration may occur independently of a payment card transaction. For example, a payment processor may host a specific website for registering cardholder computing devices. In other embodiments, registration may occur as part of an online payment transaction. For example, a cardholder may navigate to a merchant website, select items for purchase, and enter their payment card information into the merchant website using a consumer computing device. The merchant website may include code configured to cause the consumer computing device to capture transaction device information from an Internet browser of the consumer computing device and to transmit the transaction device information to device authenticator 250 (either directly or through merchant 230). Merchant 230 may also transmit a payment card number, primary account number, or similar unique identifier used during the transaction process to device authenticator 250. Based on the identifier, device authenticator may attempt to authenticate the consumer computing device by retrieving stored device information associated with the unique identifier and comparing the transaction device information to the stored cardholder device information. To the extent the stored cardholder device information and the transaction device information do not sufficiently match (i.e., to the extent the consumer computing device is not a known cardholder computing device), the device authenticator 250 may request verification of the cardholder's identity as previously discussed. If the cardholder provides adequate verification, the consumer computing device may be registered as a new cardholder computing device and the transaction device information may be stored as cardholder device information corresponding to the new cardholder computing device.

After a cardholder registers one or more cardholder computing devices with device authenticator 250, device authenticator 250 may be used to authenticate consumer 220. Authentication is generally the process of confirming that consumer 220, i.e., the entity submitting a transaction using payment card information, corresponds to the actual cardholder associated with the payment card information.

To authenticate consumer 220, device authenticator 250 may receive transaction device information from consumer 220 either directly or via one or more of merchant 230, payment processor 240, and issuer 260. In certain embodiments, transaction device information is acquired from consumer 220 via an Internet browser operating on consumer 220. Specifically, a webpage may include embedded code that, when activated by consumer 220 via the Internet browser, causes consumer 220 to transmit transaction device information to one or more of merchant 230, payment processor 240, and issuer 260. Consumer 220 may activate the embedded code by opening a website, clicking or activating a link or other control on a website, adding an item to be purchased to an electronic shopping cart, and the like. Merchant 230, payment processor 240, and issuer 260 may also provide a payment card number, primary account number, or other identifier associated with the payment card invoked during the payment card transaction. In certain embodiments, the identifier may be obtained from a payment information form completed by consumer 220.

The lifecycle of a payment card transaction may include an authorization process, a clearing process, and a settlement process. During the authorization process, transaction data for authorizing the transaction may be transmitted between merchant 230, payment processor 240, and issuer 260. For example, the transaction data may include a name, a payment card account number, a transaction amount, a date and/or a time of the transaction, and the like At this point in the transaction, the transaction data included in the authorization process may be only that data which is necessary to approve the transaction. Accordingly, the identifier corresponding to the payment card used during the payment card transaction may also be obtained from the transaction data included in the authorization process.

Based, at least in part, on the identifier and the transaction device information, device authenticator 250 may authenticate consumer 220. For example, device authenticator 250 may use the identifier to retrieve stored device information corresponding to one or more cardholder computing devices of the cardholder associated with the identifier provided by consumer 220. In accordance with systems and methods herein, device authenticator 250 may then compare the transaction device information with the stored device information to determine whether consumer 220 corresponds to a known cardholder device. If device authenticator 250 determines consumer 220 sufficiently matches a known cardholder device, consumer 220 may be authenticated as the actual cardholder and device authenticator 250 may transmit an authentication message to one or more of merchant 230, payment processor 240 or other parties within network 210. In response to the authentication message, the transaction may be permitted to proceed.

If the transaction is also authorized by issuer 260 (e.g., by confirming that the account associated with the transaction data contains sufficient funds), the issuer 260 may send notice of authorization to one or more of payment processor 240 and merchant 230. This process typically occurs within a few seconds to a few minutes of the request to authorize the transaction. After the transaction has been authorized, the transaction may be forwarded to the payment processor 240 for settlement typically later that same day, week, and the like. The settlement process includes the money being transferred from a cardholder's bank to a merchant's bank. During settlement, prior to settlement, and/or after settlement, a clearing process occurs for the transaction. The clearing process typically includes arranging bank/credit accounts for transfer of money/securities. For example, the clearing process may include payment processor 240 validating information and approving the purchase information from the merchant 230. According to various aspects, during the clearing process, the transaction data obtained during authorization may be supplemented by addendum data by the merchant 230, the payment processor 240, and the like. The clearing process may be completed after the authorization of the transaction is completed, for example, at the end of the same business day, one day later, two days later, and the like.

The addendum data may be added during a transaction lifecycle, for example, during the clearing process (if not included in the authorization process) and may include additional information about a transaction, one or more items purchased in the transaction, merchant information, cardholder information, and the like, which was not available during the authorization process. As another example, the addendum data may include information that was available during the authorization process but that was not processed during the authorization process. As yet another example, the addendum data may include information subsequently added to the transaction after the authorization process, and the like. Also, as described herein, transaction data may include authorization data and addendum data. In some examples, the authorization data and the addendum data may partially overlap, or not overlap at all. In some cases, the addendum data may be added, or partially added during the authorization process. As another example, the addendum data may be added after the authorization process.

### Example of Device Authentication Computing Device

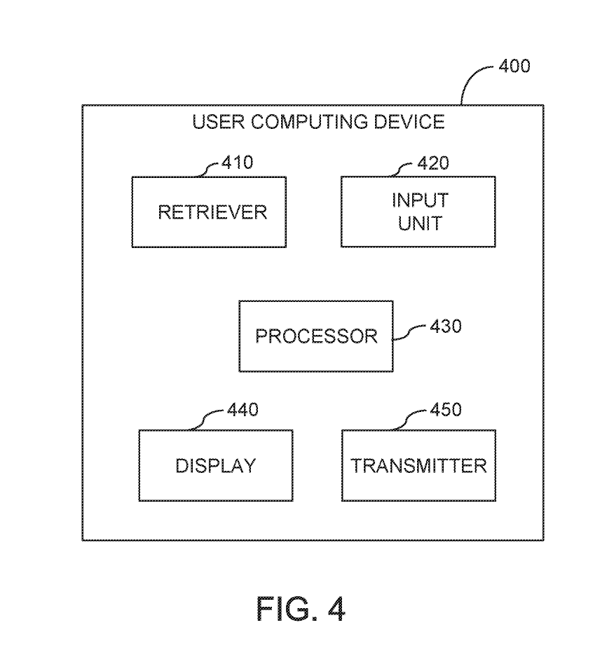

FIG. 3 is a diagram illustrating an example embodiment of a device authentication computing device that may be included in the device authentication system of FIG. 2, in accordance with an example embodiment of the present disclosure.

Referring to FIG. 3, device authentication computing device 300 may correspond to device authenticator 250 shown in FIG. 2. Device authentication computing device 300 may be coupled to payment processor 240 or may be a separate computing device included in the system of FIG. 2, and may be connected to one or more of the other computing devices via the network 210. In this example, device authentication computing device 300 includes a receiver 310, an analyzer 320, a processor 330, and a transmitter 340. Device authentication computing device 300 may include additional components not shown, or less than the amount of components shown. Also, one or more of the components in this example may be combined or may be replaced by processor 330. The computer components described herein (e.g., receiver 310; analyzer 320; processor 330; and transmitter 340) may include hardware and/or software that are specially configured or programmed to perform the steps described herein.

Receiver 310 may be configured to receive data from various sources. For example, receiver 310 may receive cardholder device information for one or more cardholder computing devices from a server of one of a payment processor, a merchant, and an issuer. The receiver 310 may receive such cardholder computing device data during a device registration process.

Receiver 310 may also receive an authentication request message during the course of an online payment transaction. A merchant or other web host may send the authentication request message to the device authentication computing device 300 in response to a request for an online payment transaction from a consumer computing device.

Receiver 310 may also receive transaction device information corresponding to the consumer computing device. The transaction device information may be captured by an Internet browser of the consumer computing device. For example, the Internet browser may execute a code snippet contained in a merchant website that causes the consumer computing device to collect transaction device information available through the Internet browser and to transmit the transaction device information, directly or indirectly (e.g., through a server associated with the merchant website), to device authentication computing device 300. Receiver 310 may receive the transaction device information as part of the authentication request message or as a separate data transmission.

Transaction device information and/or authentication requests received by receiver 310 may also include a unique identifier associated with a cardholder. For example, the transaction device information or the corresponding authentication request message may include a primary account number of the cardholder. Based on the unique identifier, receiver 310 may retrieve stored device information corresponding to the cardholder from a local storage (not shown) or from another computing device such as a remote server.

Analyzer 320 may analyze transaction device information and retrieved stored device information to extract device information for authenticating the consumer computing device. For example, analyzer 320 may filter or otherwise extract specific pieces of device information from the transaction device information and stored device information for comparison. Analyzer 320 may also group and/or categorize device information. For example, analyzer 320 may group or categorize pieces of device information based on entropy as described later in this disclosure. The extracted device information may be stored permanently or temporarily in a data storage (not shown) of device authentication computing device 300 or a computing device remote to device authentication computing device 300.

Processor 330 may further analyze and process the data received by receiver 310 and analyzed by analyzer 320. During registration, for example, processor 330 may perform any tasks associated with storing device information for newly registered cardholder computing devices. For example, processor 330 may create data structures, populate or update fields of data structures with device information obtained during the registration process, delete stored data corresponding to old cardholder computing devices, and the like.

During authentication of a consumer computing device, processor 330 may compare transaction device information received from the consumer computing device to stored cardholder device information to determine whether to authenticate the consumer computing device. In certain embodiments, processor 330 may compare stored device information for each of a set of cardholder computing devices.

As part of the comparison process, processor 330 may determine whether and to what extent the transaction device information matches the stored device information of one or more of the cardholder computing devices. In certain embodiments, processor 330 may calculate similarity scores for each cardholder computing device to quantify the degree of similarity between the transaction device information and one or more of the cardholder computing devices corresponding to the unique identifier. To do so, processor 330 may assign values and/or weights to different pieces of device information and may generate a score representing the similarity between the transaction device information and the device information for a particular cardholder computing device. To the extent processor 330 determines that the transaction device information matches or is sufficiently similar to the stored device information of one of the cardholder computing devices, processor 330 may authenticate the user computing device from which the transaction device information was obtained. Alternatively, if the device is not authenticated, processor 330 may initiate remedial measures including, but not limited to, denying the transaction, issuing a fraud alert, and the like.

In certain embodiments, device authentication computing device 300 may also include a transmitter 340 for transmitting data, including authentication results. Transmitter 340 may be configured to transmit data to a user computing device (such as the consumer computing device), a cardholder computing device, a payment processor, an issuer, a merchant, and the like. For example, if device authentication computing device 300 does not authenticate a transaction, transmitter 340 may send a fraud alert to one or more of a payment processor and a cardholder computing device to notify each of the potential fraud.

### Example of User Computing Device

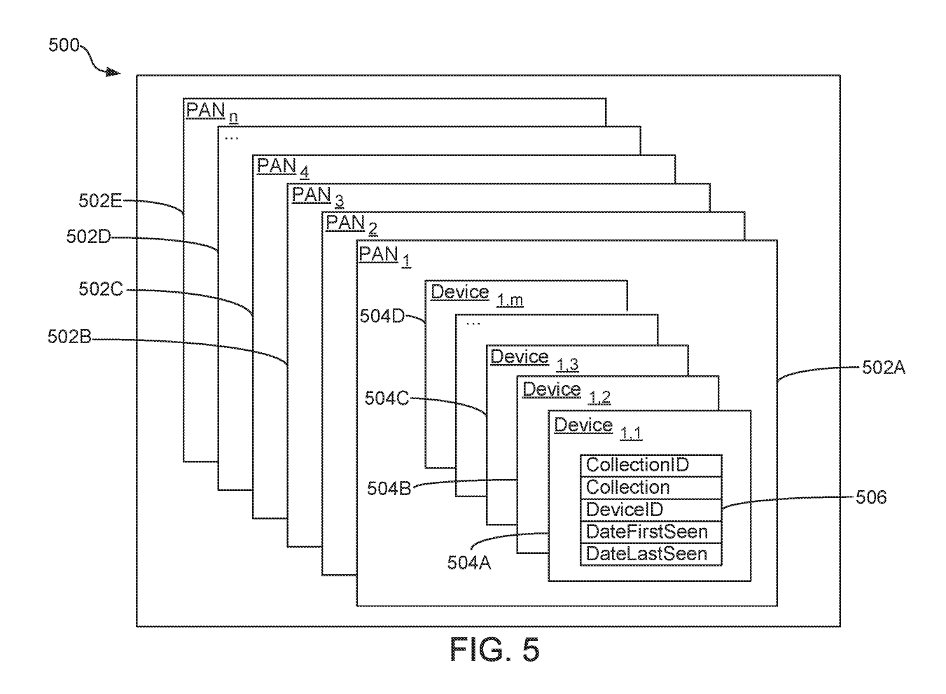

FIG. 4 is a diagram illustrating an example of a user computing device 400 that may be used to complete online payment transactions and be subject to authentication by a fraud analyzing system in accordance with this disclosure, such as device authentication system 200 of FIG. 2. More specifically, user computing device 400 may be used to communicate, directly or indirectly, with a device authentication computing device, such as device authentication computing device 300 of FIG. 3.

As used herein, the term “user computing device” refers generally to a computing device that may be used to complete an online payment transaction. The terms “consumer computing device” and “candidate cardholder computing device” are used herein to denote unauthenticated user computing devices, i.e., user computing devices for which it is unknown whether the user computing device corresponds to a known user computing device of a cardholder. In contrast, the term “cardholder computing device” is used herein to denote a user computing device known to be associated with a cardholder. For example, a cardholder computing device may be a user computing device registered by a cardholder during a registration process or may be an authenticated consumer computing device. Finally, the term “non-authenticated computing device” is used to denote a consumer computing device that fails an authentication process.

Referring to FIG. 4, user computing device 400 may be used to complete online payment transactions. In this example, the user computing device 400 includes a receiver 410, an input unit 420, a processor 430, a display 440, and a transmitter 450. User computing device 400 may be, for example, a laptop computer, a mobile phone, a smart phone, a tablet, a desktop computer, an MP3 player, and the like. Also, although the different features are separately illustrated, one or more of the features may be omitted, combined with other features, and the like. For example, one or more of the features may be operated by or controlled by processor 430.

User computing device 400 may be used to complete an online payment transaction in conjunction with device authentication system 200 of FIG. 2. For example, using an Internet browser, a user may access a website capable of conducting online payment transactions. Using input unit 420, the consumer may navigate through the website, select products or services to purchase, and provide transaction information including, but not limited to, a payment card number, a payment card expiration date, a name, a billing address, and the like. Input unit 420 may be used to enter inputs into user computing device 400, including inputting information corresponding to an online transaction, cardholder account information, and the like. Input unit 420 may include at least one of a keyboard, a mouse, a motion recognizer, a camera, a speech recognition module, and the like.

Transmitter 450 may transmit data including but not limited to, transaction device information. Transmitter 450 may transmit any data directly or indirectly (e.g., through a server hosting the website or application) from user computing device 400 to other computing devices, including a device authentication computing device such as device authentication computing device 300 of FIG. 3. The data transmitted by transmitter 450 may also be sent to any other computing device in a device authentication system, including, but not limited to a payment processor, a merchant, an issuer, and the like.

In embodiments according to this disclosure, user computing device 400 may be a consumer computing device that is to be authenticated prior to completion of online payment transactions entered into with user computing device 400. Generally, authentication includes determining whether user computing device 400 corresponds to a known cardholder computing device. To authenticate user computing device 400, user computing device 400 may transmit transaction device information obtainable through an Internet browser operating on user computing device 400. For example, a user may use an Internet browser run on user computing device 400 to open a website embedded with code that is then executed by user computing device 400. The code may cause user computing device 400 to collect and transmit device information describing user computing device 400. In other embodiments, similar code may be executed in response to a user activating a button or other control on the website, inputting payment information, adding items to an electronic shopping cart, or otherwise taking any steps associated with an online payment transaction. In still other embodiments, user computing device 400 may be configured to provide the device information in response to a request received from another computing device, such as device authentication computing device 300 of FIG. 3.

### Example Storage of Device Information

In systems and methods described herein, a device authentication computing device retrieves stored cardholder device information for comparison to transaction device information. The stored cardholder device information generally includes device information corresponding to one or more cardholder computing devices and is stored in a collection of device information specifically associated with the cardholder.

In certain embodiments, a storage system for storing cardholder device information may include a set of unique identifiers for identifying particular cardholders. The unique identifier may generally be used as a unique key in the storage system and, as a result, may be used to look up device information associated with a cardholder. A payment processor implementing a device authentication computing device as described herein may already have a system of unique identifiers for identifying cardholders. For example, a payment processor may assign a unique primary account number to each of their cardholders. Accordingly, in certain embodiments, the unique identifier used in the storage system may be a primary account number previously assigned to the cardholder by the payment processor. For simplicity, primary account numbers are used in the following discussion as an example of a unique identifier; however, embodiments of systems and methods described herein are not limited to using primary account numbers as a unique identifier.

Each primary account number in storage systems in accordance with this disclosure may further be associated with a set of cardholder computing devices, the set of cardholder computing devices corresponding to known computing devices of the cardholder associated with the primary account number. In turn, each cardholder computing device within a set of cardholder computing devices may be further associated with device information obtained from a corresponding cardholder computing device. In certain embodiments, this storage arrangement may be implemented using various data structures. For example, a “PAN” data structure may be created or instantiated in the storage system for each primary account number in the storage system. Accordingly, in certain embodiments, a storage system Ψ may be expressed as:

Ψ={P₁,P₂,P₃ . . . P_{z}} (1)

where P represents a PAN and z is the maximum number of PANs in storage system Ψ. Each PAN in storage system Ψ may be identified by a unique identifier.

Each PAN may further include one or more “Device” data structures with each Device corresponding to a cardholder computing device of the cardholder associated with the PAN. Accordingly, in certain embodiments, each PAN Pₙ may be expressed as:

Pₙ={σₙ(1),σₙ(2),σₙ(3) . . . σₙ(m)} (2)

where σ represents a Device data structure, n represents the nth PAN, and m represents the maximum number of Device data structures for a given PAN. So, for example, σ₃(2) corresponds to the second Device of the third PAN of a given storage system.

Each Device may further include a set of values and variables corresponding to various pieces of information associated with the Device. For example, each Device may include a “Collection” data structure for storing device information corresponding to the Device. The device information stored within a Collection may include device information retrievable through an Internet browser, including but not limited to: a browser engine name, a screen color depth, a system operating system (OS), a system central processing unit (CPU), a system platform, a browser name, a browser engine version, a browser version, a user agent string, a user OS, a user platform, screen width, screen height, system language, time zone, http headers, browser language, a cookies enabled indicator, a plugins installed indicator, and the like.

In certain embodiments, the data contained in a Collection may be hashed to create a “CollectionID” representing a condensed form of the data stored within the Collection. As described below in more detail, the value of variables and data stored within a Collection may vary over time. Accordingly, to the extent values of variables contained in a Collection change, the corresponding CollectionID may be updated by rehashing the updated values stored in the Collection and using the result as an updated CollectionID.

In addition to a Collection and CollectionID, a Device may include other data including, but not limited to: a “DateFirstSeen” variable indicating the date the cardholder device was first used or registered, a “DateLastSeen” variable indicating the date the cardholder device was most recently used, and a “DeviceID” assigned to the cardholder computing device. In certain embodiments, the DeviceID may be a fixed value assigned when a Device is first created and may be assigned the initial value of the CollectionID.

In light of the foregoing, an exemplary Device data structure (corresponding to a first Device of the first PAN in a storage system) according to certain embodiments may be expressed as:

σ₁(1)={DeviceID₁(1),CollectionID₁(1),DataFirstSeen₁(1),DateLastSeen₁(1),Collection₁(1)} (3)

An exemplary Collection, specifically Collection₁(1), may be further expressed as:

Collection₁(1)={UA₁(1),BE₁(1),BEV₁(1),UOS₁(1),UP₁(1),SW₁(1),SH₁(1),SCD₁(1),SL₁(1),OS₁(1),CPU₁(1),SP₁(1),TZ₁(1),H₁(1),Br₁(1),Bv₁(1), Bl₁(1),C₁(1),PI₁(1)} (4)

where each of the data elements in Collection_{1,1} corresponds to a specific piece of device information. In the example of equation (4), Collection_{1,1} includes: user agent (UA), browser engine name (BE), browser engine version (BEV), operating system (UOS), platform (UP), screen width (SW), screen height (SH), screen color depth (SCD), system language (SL); system OS (OS), system CPU (CPU), system platform (SP), time zone (TZ), HTTP headers (H), browser name (Br); browser version (Bv), browser language (Bl), cookies enabled (C), and plugins installed (PI).

A device authentication computing device may create data structures corresponding to a cardholder computing device in storage systems according to this disclosure during a registration process. Registration generally refers to the process of verifying a cardholder computing device and obtaining and storing cardholder device information corresponding to the cardholder computing device. Verification of the cardholder computing device may require a cardholder to provide a password, answer security questions, verify previous transactions, provide an authentication code sent to the cardholder by email or text message, and the like.

The device authentication computing device may create a new PAN when a cardholder registers a first cardholder computing device. Provided a PAN exists or has been created for the cardholder, the device authentication computing device may then add a new Device data structure to the PAN and populate a Collection of the Device with device information obtained from the cardholder computing device.

Device information may be obtained from the cardholder computing device at any point during the registration process. For example, in certain embodiments, a payment processor, merchant, or issuing bank may host a website for registering cardholder computing devices. Code snippets or scripts may be embedded in the website and executed by the cardholder computing device as the cardholder navigates or activates controls on the website using an Internet browser. Once executed, the code snippets may cause the cardholder computing device to retrieve device information available from the Internet browser and to transmit the device information to the payment process, merchant, or issuing bank hosting the website. The payment process, merchant, or issuing bank may then transmit the device information to the device authentication computing device for storage and organization in a storage system in accordance with this disclosure.

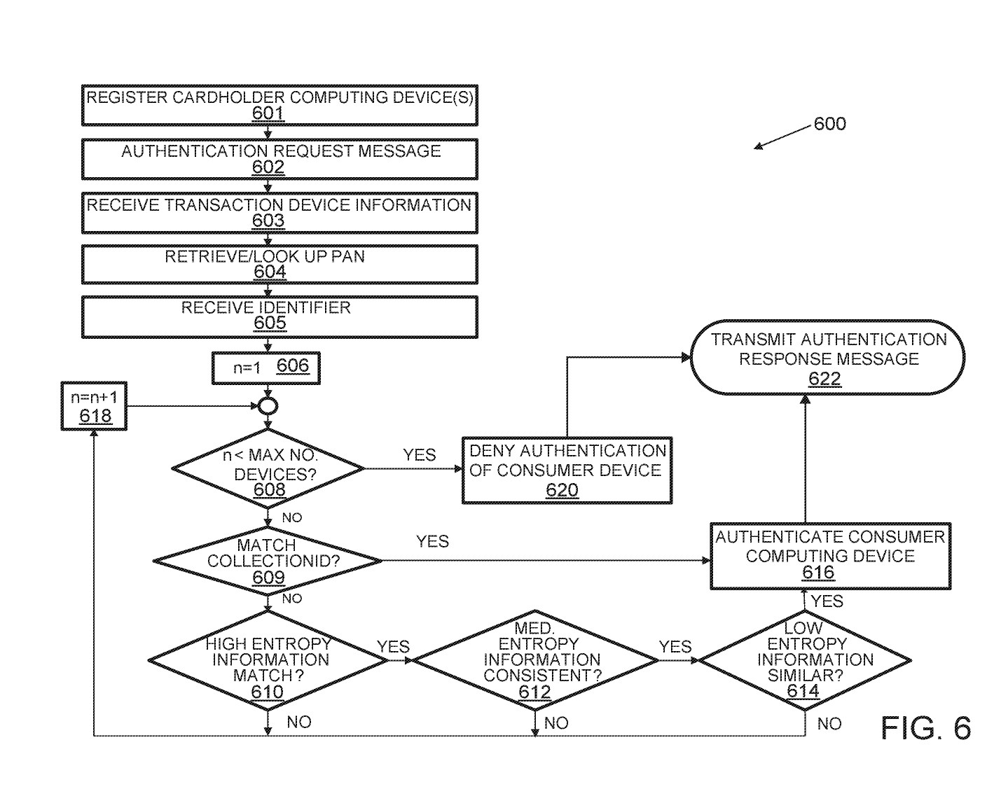

FIG. 5 is an example of a storage system 500 according to one embodiment of the present disclosure. Storage system 500 includes a plurality of PAN data structures, generally identified in FIG. 5 as PAN₁-PANₙ 502A-502E. As previously discussed, a PAN data structure generally stores device information corresponding to a set of cardholder computing devices. The total number of PAN data structures that may be contained in a storage system in accordance with this disclosure is not limited to any particular number. Accordingly, PANₙ 502E is intended to represent the nth PAN in storage system 500, where n is any number.

PAN₁ 502A is intended to be exemplary of each of PAN₁ through PANₙ. Each PAN data structure may contain one or more Device data structures that further contain device information obtained from cardholder computing devices. PAN₁, for example, includes Device_{1,1} through Device_{1,m}, where m is the maximum number of Device data structures associated with PAN₁ and m may be any suitable number. In addition to storing one or more Device data structures, each PAN may also store additional information, including but not limited to a unique identifier; cardholder information such as a cardholder name, address, and the like; passwords; and security questions and answers.

In certain embodiments, storage system 500 may be limited such that each PAN may only contain a predetermined maximum number of Device data structures. For example, each PAN may only include a maximum of five Device data structures. If the maximum number of Device data structures for a PAN is reached, when a cardholder attempts to register a new cardholder computing device, a Device data structure of the PAN may be removed or replaced to permit the addition of the new Device. In certain embodiments, the Device to be removed or replaced may be automatically chosen by the device authentication computing device. For example, the device authentication computing device may automatically choose to remove or replace the least recently used Device as determined by the DateLastSeen value of the Device. Alternatively, the cardholder may be asked during the registration process to identify one or more cardholder computing devices to remove or replace. The cardholder may then select one or more cardholder computing devices that the cardholder no longer uses, uses less frequently, and the like. The device authentication computing device may then remove the corresponding Device from the PAN in order to make room for the new Device.

Device_{1,1} 504A is intended to be exemplary of Device data structures stored in any of PAN₁ 502A to PANₙ 502E. Each Device contains device information and other data associated with a cardholder computing device. For example, Device_{1,1} 504A stores device information of a first cardholder computing device associated with the cardholder of PAN₁ 502A. As depicted in table 506, the device information stored in Device_{1,1} may include but is not limited to a CollectionID, a Collection, a DeviceID, a DateFirstSeen, and a DateLastSeen, all of which are described in more detail above.

### Example Authentication of a Consumer Computing Device

In systems and methods described herein, a consumer computing device is authenticated during an online payment transaction by a device authentication computing device. Authentication is performed based, at least in part, on a comparison of stored cardholder device information corresponding to known cardholder computing devices and transaction device information obtained from the consumer computing device during the course of the online payment transaction. In addition to transaction device information and stored cardholder device information, authentication may also be based, in part, on other data obtained during the course of a payment card transaction including, but not limited to, payment card information provided by a consumer and transaction data obtained during one or more of an authorization process, a clearing process, and a settlement process.

The authentication process may begin when a consumer attempts to complete a payment card transaction on a merchant website using an Internet browser of a consumer computing device. In response to the consumer's attempts, the merchant, a web host hosting the merchant website, or other party, such as a payment processor, may transmit an authentication request message to the device authentication computing device. The device authentication message may contain information including, but not limited to, payment information provided by the consumer, information regarding the merchant, information regarding the attempted purchase, identifying information regarding the consumer computing device, and the like.

Transaction device information may also be obtained from the consumer computing device. For example, the website may include embedded code that, when executed, causes the consumer computing device to capture transaction device information through the Internet browser and to transmit the transaction device information to the device authentication computing device. In certain embodiments, such code may be executed in response to a consumer activating a button or other control on the website, inputting payment information, adding items to an electronic shopping cart, or otherwise taking any steps associated with completing the online payment transaction. In other embodiments, the consumer computing device may be configured to provide the device information in response to a request received from another computing device, such as a device authentication computing device. For example, the device authentication computing device may send a request for device information to the consumer computing device in response to the device authentication computing device receiving an authentication request message.

In certain embodiments, transaction device information sent by the consumer computing device and received by the device authentication computing device may be expressed generally as:

τ={CollectionID_{τ},Collection_{τ}} (5)

where τ represents a transaction, Collection_{τ} represents the collection of transaction device information, and CollectionID_{τ} represents a hashed value of Collection_{τ}. Collection_{τ} may be further expressed as:

Collection_{τ}={UA_{τ},BE_{τ}, BEV_{τ},UOS_{τ},UP_{τ},SW_{τ},SH_{τ},SCD_{τ},SL_{τ},OS_{τ},CPU_{τ},SP_{τ},TZ_{τ},H_{τ},Br_{τ},Bv_{τ},Bl_{τ},C_{τ},PI_{τ}} (6)

where each of the data elements in Collection_{τ} corresponds to a specific piece of transaction device information. In the example of equation (6), Collection_{τ} includes: user agent (UA), browser engine name (BE), browser engine version (BEV), operating system (UOS), platform (UP), screen width (SW), screen height (SH), screen color depth (SCD), system language (SL); system OS (OS), system CPU (CPU), system platform (SP), time zone (TZ), HTTP headers (H), browser name (Br); browser version (By), browser language (Bl), cookies enabled (C), and plugins installed (PI).

The authentication request message or the transaction device information may further include an identifier corresponding to the cardholder whose payment information is being used by the consumer for the online purchase transaction. For example, the consumer may provide a primary account number identifying the account from which funds are to be deducted as part of the online payment transaction. In certain embodiments, such an identifier may be obtained by the device authentication computing device from authorization data submitted to a payment card network in connection with the online payment transaction.

The device authentication computing device may use the identifier to retrieve a PAN data structure containing stored device information corresponding to cardholder computing devices of the cardholder associated with the identifier. For purposes of this example, it is assumed that a PAN data structure has already been created for the cardholder associated with the identifier.

After the PAN is retrieved, the device authentication computing device may compare the transaction device information to the device information stored in the Collection of each Device in the PAN. Based on the comparison, the device authentication computing device may transmit an authentication response message to the merchant, the website host of the merchant, the payment processor, or any other suitable party. To the extent the device authentication computing device determines that the device information of a Device within the PAN matches or is sufficiently similar to the transaction device information, the device authentication computing device may transmit an authentication response message indicating that the consumer computing device is authenticated. If, on the other hand, the device authentication computing device determines that the transaction device information does not match or is not sufficiently similar to the device information of any Device in the PAN, the device authentication computing device may transmit an authentication response message indicating that the device authentication computing device declined authentication of the consumer computing device. The device authentication computing device may also take additional remedial measures such as rejecting the transaction, delaying the transaction for further review and approval, issuing a fraud alert, requesting verification or registration of the user computing device by the user, and the like.

In certain embodiments, the device authentication computing device may initially compare the CollectionID values of the transaction device information to that of the current Device. As previously discussed, the CollectionID is a hashed value of the data contained in a corresponding Collection. Accordingly, to the extent CollectionID_{τ} (i.e., the hashed value of the transaction device information obtained from the consumer computing device) matches the CollectionID of the current Device, the device authentication computing device may consider the consumer computing device to be a match for the current Device and may authenticate the consumer computing device, for example, by transmitting an authentication response message notifying one or more of the merchant, a web host of the merchant, or another party, such as a payment processor, that the consumer computing device is authenticated.

To the extent the CollectionID values do not match, the device authentication computing device may compare the transaction device information to the stored device information contained in the PAN by successively comparing device information having lower entropy. The term entropy, as used herein, generally refers to the degree of certainty with which a device may be identified based on a given piece of device information. For example, a serial number that uniquely identifies a computing device has high entropy because a discrepancy between a first serial number contained in transaction device information and a second serial number stored in a Collection of a PAN is a clear indication that the consumer computing device is not the same as the cardholder computing device associated with the Collection. In contrast, the language setting of an Internet browser, for example, has low entropy because such a setting may not generally be used on its own to determine whether two user computing devices are the same. However, while individual pieces of low entropy device information on their own may not clearly indicate whether two user computing devices are the same, low entropy device information taken in the aggregate may demonstrate at least some similarity between two user computing devices.

For each Device in the retrieved PAN, the device authentication computing device may first compare high entropy transaction device information to high entropy device information stored in the Collection of the Device. To the extent the two sets of high entropy transaction device information do not match, the Device may be rejected as a possible match for the consumer computing device and the next Device may be considered. In general, high entropy device information corresponds to device information that is unique and/or unlikely to change over the course of a device's use. High entropy device information may include, but is not limited to: a browser engine name, screen color depth, a system OS, a system CPU, a system platform, and a browser name. In light of the foregoing, the test for comparing high entropy transaction device information to high entropy device information stored in a Collection (for this example, Collection₁(1), i.e., the Collection corresponding to the first Device of the first PAN in the storage system) in certain embodiments may be expressed as follows:

If (OS_{τ}=OS₁(1) AND SP_{τ}=SP₁(1) AND CPU_{τ}=CPU₁(1) AND SCD_{τ}=SCD₁(1) AND Br_{τ}=Br₁(1) AND BE_{τ}=BE₁(1))→Proceed to medium entropy test (7)

Alternatively, the comparison test for high entropy transaction device information to high entropy device information stored in a Collection may be expressed as follows:

If (OS_{τ}=OS₁(1) OR SP_{τ}=SP₁(1) OR CPU_{τ}=CPU₁(1) OR SCD_{τ}=SCD₁(1) OR Br_{τ}=Br₁(1) OR BE_{τ}=BE₁(1))→Exclude Device₁(1) as potential match for consumer computing device (8)

If the device authentication computing device determines that the high entropy transaction device information matches the high entropy device information stored in the Collection of the current Device, the device authentication computing device may then compare medium entropy transaction device information to the medium entropy device information stored in the Collection of the current Device. Such device information may include device information that, while variable, tends to change in a predictable way. Medium entropy device information may include, but is not limited to, browser engine version or browser version. Notably, each of browser engine version and browser version tend to increase over time as a browser on a device is updated. Accordingly, to the extent the device authentication computing device determines that medium entropy transaction device information differs unpredictably from the medium entropy device information in the Collection of the current Device, the current Device may be excluded as a potential match to the consumer computing device. In light of the foregoing, the test for comparing medium entropy transaction device information to medium entropy device information stored in a Collection (for this example, Collection₁(1), i.e., the Collection corresponding to the first Device of the first PAN in the storage system) in certain embodiments may be expressed as follows:

If (Bvτ<Bv₁(1))→Exclude Device₁(1) as potential match for consumer computing device; OR

If (Bvτ=Bv₁(1)) AND (BEV_{τ}!=BEV₁(1))→Exclude Device₁(1) as potential match for consumer computing device; OR

If (Bvτ>Bv₁(1)) AND (BEVτ<BEV₁(1))→Exclude Device₁(1) as potential match for consumer computing device (9)

If the medium entropy transaction device information is consistent with the medium entropy device information of the Collection of the current Device, the device authentication computing device may then compare low entropy device information. Low entropy device information generally includes device information that is likely to change and/or is readily modifiable by a user. For example, low entropy device information may include, but is not limited to: a user agent, an operating system, a platform, screen width, screen height, system language, time zone, http headers, browser language, whether cookies are enable, and whether certain plugins are installed.

As previously discussed, differences in individual pieces of low entropy device information are generally insufficient to definitively conclude whether two user computing devices are the same, but may provide reasonable certainty of such similarity when considered in the aggregate. Accordingly, in some embodiments, the device authentication computing device may compare multiple pieces of low entropy device information when authenticating a user computing device. To do so, the device authentication computing device may generate a similarity score between the transaction device information and that stored in the Collection of the current Device. To generate the similarity score, each piece of device information may be given equal weight or certain pieces of device information may be weighted to reflect relative entropies between the pieces of device information. After the device authentication computing device calculates a similarity score, it may compare the similarity score to a threshold similarity value in order to determine whether to authenticate the transaction device or to initiate remedial measures. In certain embodiments, a routine for determining a similarity score between transaction device information obtained from a consumer computing device and stored device information of the Collection of the current Device (for this example, Collection₁(1), i.e., the Collection corresponding to the first Device of the first PAN in the storage system), may be expressed as follows:

similarity₁(1)=0

If (SW_{τ}=SW₁(1))→similarity₁(1)=similarity₁(1)+W(SW)

If (SH_{τ}=SH₁(1))→similarity₁(1)=similarity₁(1)+W(SH)

If (TZ_{τ}=TZ₁(1))→similarity₁(1)=similarity₁(1)+W(TZ)

If (Bl_{τ}=Bl₁(1))→similarity₁(1)=similarity₁(1)+W(Bl)

If (C_{τ}=C₁(1))→similarity₁(1)=similarity₁(1)+W(C)

If (SL_{τ}=SL₁(1))→similarity₁(1)=similarity₁(1)+W(SL)

If (H_{τ}=H₁(1))→similarity₁(1)=similarity₁(1)+W(H)

If (UOS_{τ}=UOS₁(1))→similarity₁(1)=similarity₁(1)+W(UOS)

If (Pl_{τ}=Pl₁(1))→similarity₁(1)=similarity₁(1)+W(Pl)

where similarity is a similarity score representing the similarity between the low entropy transaction device information and the low entropy device information stored in the Collection of the current Device and W represents a weighting function for weighting pieces of low entropy device information. To the extent the similarity of the transaction device information and Collection of the current Device exceeds a predetermined threshold (for example, if there is greater than a 90% match between the two sets of device information), the device authentication computing device may authenticate the consumer computing device and transmit an authentication response message to one or more of the merchant, a web host of the merchant, and other parties, such as the payment processor. If the similarity falls below a predetermined threshold, the device authentication computing device may exclude the current Device as a potential match to the consumer computing device.

If each Device in the PAN is excluded as a possible match for the consumer computing device, the device authentication computing device may reject the authentication request corresponding to the consumer computing device. As part of a rejection, the device authentication computing device may transmit an authentication response message to one or more of the merchant, a web host of the merchant, and other parties, such as the payment processor indicating that the consumer device was not authenticated. Device authentication computing device may also take further remedial measures including, but not limited to, initiating a registration process for the consumer computing device, declining the transaction, flagging the transaction for additional investigation, issuing a fraud alert, freezing the cardholder's account, and the like.

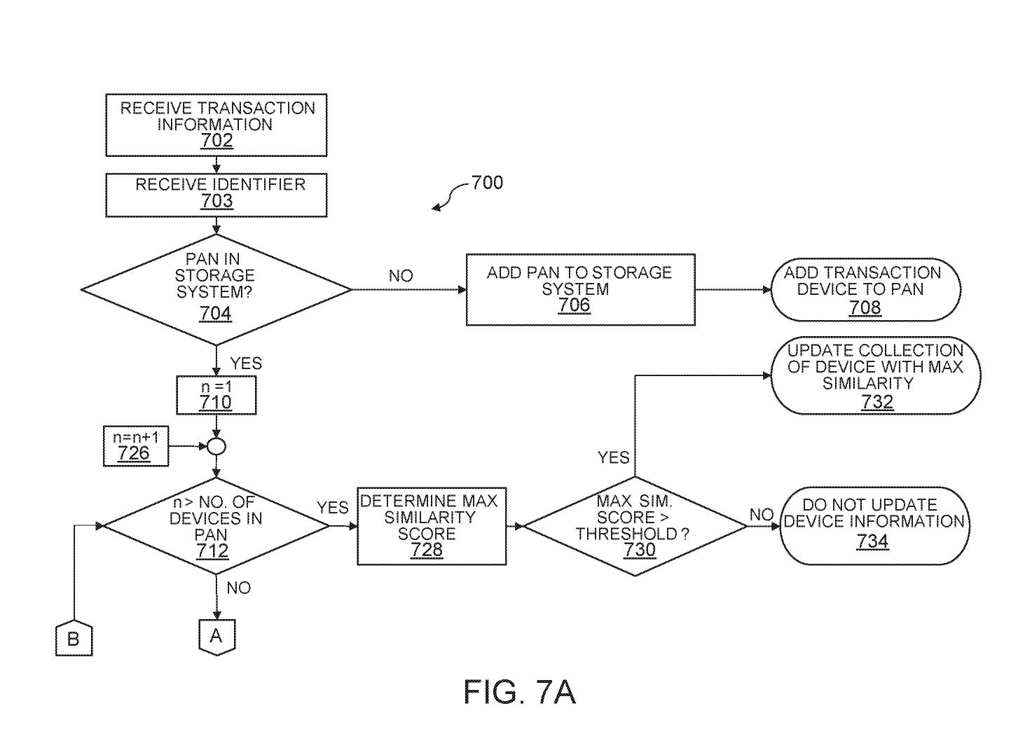

FIG. 6 is a flow chart illustrating an example embodiment of a method for authenticating a user computing device using a device authentication computing device, such as device authentication computing device 300 of FIG. 3.

Initially, a cardholder registers at least one cardholder computing device 601. As discussed in this disclosure, registration generally refers to the process of verifying a cardholder computing device and obtaining and storing cardholder device information corresponding to the cardholder computing device. Registration may be conducted as part of an online payment transaction or may be conducted independently of a payment card transaction. During the registration of a first cardholder computing device associated with a cardholder, a PAN data structure is created in a storage system in accordance with this disclosure. The PAN data structure is further populated with a Device data structure containing a Collection of device information corresponding to the cardholder computing device and obtained from an Internet browser run on the cardholder computing device. To the extent the cardholder registers additional cardholder computing devices, a Device and associated Collection are added to the PAN corresponding for each additional cardholder computing device subject to any limitations on the maximum number of cardholder computing devices that may be registered.

When a consumer subsequently attempts to perform an online payment transaction using payment information associated with the cardholder, the device authentication computing device may receive an authentication request 602 from a merchant, a web host, or another party, such as a payment processor, associated with a website through which the consumer is attempting to perform the online payment transaction.

To authenticate the consumer computing device, the device authentication computing device receives transaction device information from the consumer computing device 603. Transaction device information may be retrieved from the consumer computing device during the online payment transaction. The transaction device information generally consists of device information retrievable through an Internet browser or similar application running on the consumer computing device. In certain embodiments, a merchant website may include a code snippet or script such that when the Internet browser is used to navigate to the website or execute a control on the website, the consumer computing device is made to execute the code snippet or script. The code snippet or script may cause the consumer computing device to capture the transaction device information available through the Internet browser and to transmit the transaction device, directly or indirectly, to the device authentication computing device. In other embodiments, the transaction device information may be sent in response to a request received by the consumer computing device. For example, the device authentication computing device may transmit a transaction device request message, directly or indirectly, to the consumer computing device that causes the consumer computing device to capture and transmit the transaction device information.

In addition to the transaction device information, the device authentication computing device may receive a payment card account number, primary account number, or other identifier 603 from the consumer computing device, the merchant, a web host associated with the merchant, the payment processor, and the like. For example, the user of the consumer computing device may provide a payment card number or similar identifier as part of completing a purchase on the merchant's website. When the user submits the payment card information, the merchant website may submit the identifier to the device authentication computing device. In other embodiments, the identifier may be stored in a cookie or similar token on the consumer computing device and the merchant website may include a code snippet or script that causes the user computing device to transmit the value in the token to one of the merchant and the device authentication computing device. In still other embodiments, the identifier may be extracted from transaction data including, but not limited to, authorization data.

Based on the identifier, the device authentication computing device retrieves or looks up a PAN 604 stored in a storage system, such as storage system 500 of FIG. 5, including one or more Device data structures corresponding to the previously registered cardholder computing devices of the cardholder.

To authenticate the consumer computing device, the device authentication computing device generally determines whether the transaction device information is sufficiently similar to stored device information corresponding to a registered cardholder computing device. Method 600 generally loops through each Device data structure of the retrieved PAN and compares the transaction device information to cardholder device information stored in the Collection data structure of each Device. Accordingly, after a PAN has been retrieved, a counter or similar variable may be initialized 606 to track the current Device of the PAN. In method 600, comparison of the transaction device information to the device information contained in the current Device is illustrated as a multi-step process in which each step consists of comparing device information of progressively lower entropy. As an initial check, the device authentication computing device may compare the CollectionID corresponding to the online payment transaction to that of the current Device. To the extent a CollectionID does not exist for the online payment transaction, the device authentication computing device may determine the CollectionID corresponding to the transaction device information by hashing the transaction device information. By comparing the CollectionID to the hashed value of the transaction device information, the device authentication computing system may readily determine if the transaction device information matches the cardholder device information contained in the Collection of the current Device. Accordingly, to the extent the CollectionID of the transaction device information matches that of the current Device, the device authentication computing device may authenticate the consumer computing device 616.

If the CollectionID of the current Device does not match that of the transaction device information, the device authentication computing device may compare the high entropy device information of the transaction device information to that of the current Device. As previously discussed, high entropy device information generally remains constant throughout the life of a given computing device and is a relatively strong predictor of whether two computing devices are the same. Accordingly, if the high entropy device information does not match between the transaction device information and that contained in the Collection of the current Device, the consumer computing device is unlikely to correspond to the cardholder computing device represented by the current Device. As a result, the cardholder computing device represented by the current Device may be rejected as a potential match for the consumer computing device, the counter may be incremented 618, and the subsequent Device of the PAN may be tested as a potential match for the consumer computing device.

If all high entropy device information matches, the device authentication computing device may then compare medium entropy device information 612. As previously discussed, medium entropy device information tends to either remain constant over or vary in a predictable manner over a computing device's life. Accordingly, to the extent the medium entropy transaction device information does not match or vary predictably with that contained in the Collection of the current Device, the user computing device is unlikely to correspond to the cardholder computing device represented by the current Device. As a result, the cardholder computing device represented by the current Device may be rejected as a potential match for the consumer computing device, the counter may be incremented 618, and the subsequent Device of the PAN may be tested as a potential match for the consumer computing device.

The device authentication computing device may then determine if the low entropy transaction device information is sufficiently similar to that of the current Device 614. As previously discussed, low entropy device information may vary during a cardholder's ownership of a given device; however, when considered in the aggregate, low entropy device information may provide a useful indication of similarity between user computing devices. In certain embodiments, determining whether low entropy transaction device information is sufficiently similar to that of the current Device may include assigning weights to different pieces of device information, calculating a similarity score based on the assigned weights, and determining whether the similarity score exceeds a predetermined similarity threshold. If there is sufficient similarity between the low entropy transaction device information and that of the current Device, the user computing device may be authenticated 620, otherwise, the current Device may be rejected and the next Device of the PAN may be subjected to the comparison process.

At the conclusion of method 600, the device authentication computing device determines whether to deny authentication of the consumer computing device 620 or to authenticate the consumer computing device 616. In either case, the device authentication computing device may transmit an authentication response message 622 indicating the outcome of the authentication process. The device authentication computing device may transmit the authentication response message to one or more of the merchant, a webhost of the merchant, or other parties, such as the payment processor or issuing bank. If the device authentication computing device does not authenticate the consumer computing device, may initiate further remedial actions including, but not limited to, freezing the cardholder account, issuing a fraud alert, performing additional fraud analysis, and the like.

### Example of Updating Stored Device Information

Systems and methods in accordance with this disclosure may further support updating stored cardholder device information. Updating stored device information may include creating a new PAN data structure, adding new Device data structures to an existing PAN, removing old Device data structures from a PAN, updating device information contained in a Collection of an existing Device, and the like.

Device authentication computing devices in accordance with this disclosure, such as device authentication computing device 300 of FIG. 3, may create new PAN data structures for cardholders in storage systems such as storage system 500 of FIG. 5. Creation of a new PAN generally occurs when a cardholder registers a cardholder computing device. In certain embodiments registration may be performed through a website hosted by one or more of a merchant, a payment processor, an issuing bank, and the like and may occur independently of an online payment transaction. In other embodiments, the registration may occur when a cardholder attempts to make an online payment transaction using a cardholder computing device. During either registration process, device information is collected from an Internet browser operating on the cardholder computing device and sent to the device authentication computing device. The device authentication computing device may then create a PAN corresponding to the cardholder.

After a PAN is created, a Device data structure corresponding to the newly registered cardholder computing device may be added to the PAN. Additional Device data structures may be added to an existing PAN independently of a payment card transaction (for example through a device registration website hosted by one or more of a merchant, a payment processor, and an issuing bank) or as part of a subsequent payment card transaction. Generally, to add a Device to a PAN, the device authentication computing device obtains device information corresponding to the cardholder computing device corresponding to the new Device, creates the new Device in the PAN, and populates a Collection data structure of the new Device with the collected device information.

The device authentication computing device may also permit removal of a Device from a PAN. Similar to registration, removal of a Device may occur independently or as part of an online payment transaction. In certain embodiments, for example, a cardholder may navigate to a website or use an application to unregister a cardholder computing device of the cardholder. Unregistering a device may be desirable, for example, if a cardholder loses, breaks, sells, replaces, or otherwise disposes of a previously used cardholder computing device and does not intend to conduct any future online payment transactions using the cardholder computing device. When a cardholder unregisters a cardholder computing device, the device authentication computing device may delete from the storage system the corresponding Device of the PAN. To the extent a deleted Device is the last Device of a PAN, the device authentication computing device may also delete the PAN from the storage system.

In certain embodiments, a Device may be automatically removed from a PAN. For example, the device authentication computing device may be configured to automatically remove a Device of a PAN corresponding to a cardholder computing device that has not been used to conduct an online payment transaction for a predetermined time. To do so, the device authentication computing device may determine whether the DateLastSeen value of the Device exceeds a certain number of days, weeks, months, or the like.

In certain embodiments, an existing Device may be replaced by a new Device corresponding to a newly registered cardholder computing device. A replacement process may be necessary in embodiments in which the number of Device data structures associated with a given PAN is limited. In such embodiments, adding a new Device to a PAN having the maximum number of Device data structures requires removal of an old Device from the PAN prior to the addition of the new Device. The device authentication computing device may look at one or more variables or statistics to determine which old Device of the PAN to replace with the new Device. For example, in certain embodiments, the device authentication computing device may determine which Device of the PAN corresponds to a least recently used cardholder computing device and replace that Device with the new Device. Alternatively, the device authentication computing device may determine which Device of the PAN corresponds to a least frequently used cardholder computing device and replace the Device with the new Device.

Device information of a cardholder computing may change over the lifetime of the cardholder computing device. For example, a cardholder may update software or firmware to more recent versions, may delete cookies or similar tokens, or may adjust a wide range of settings of the cardholder computing device. As a result, it may also be necessary to update the device information stored in the Collection of the Device corresponding to the cardholder computing device. In certain embodiments, device information stored in a Collection may be updated manually by a cardholder. For example, the cardholder may access a website or run an application on a previously registered cardholder computing device to manually submit updated cardholder device information to the device authentication computing device. The device authentication computing device may then use the cardholder device information to update the Collection of the Device associated with the cardholder computing device. In certain embodiments updating a Collection may occur automatically. For example, if a device authentication computing device authenticates a consumer computing device during the course of an online payment transaction, the device authentication computing device may update the device information stored in the Collection of the Device corresponding to the cardholder computing device to reflect the transaction device information obtained from the consumer computing device.

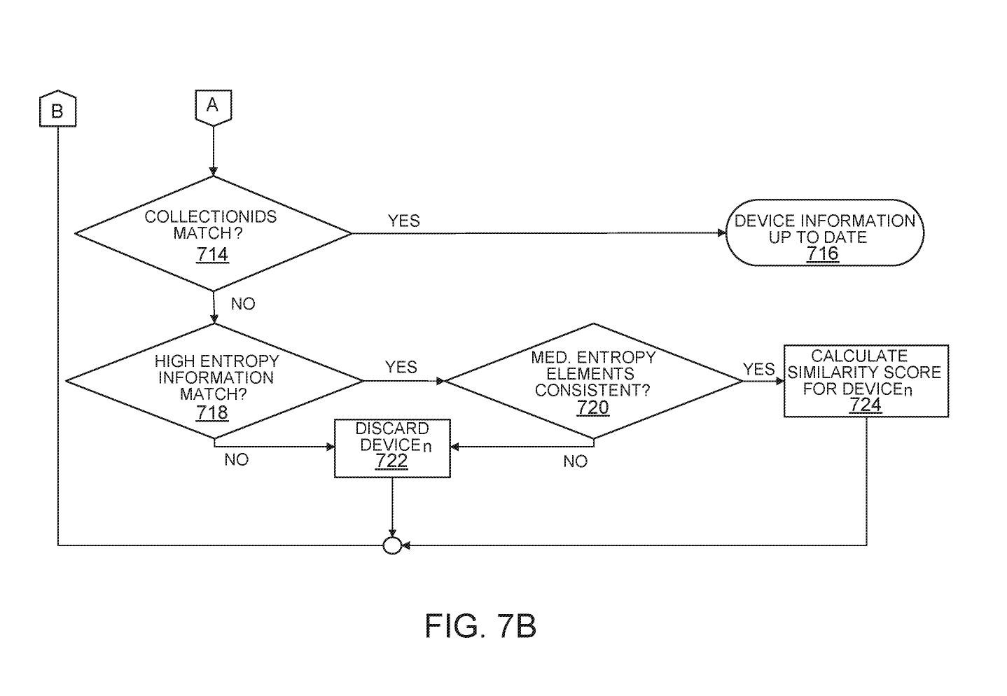

FIGS. 7A and 7B depict a method 700 for updating stored device information in accordance with an embodiment of the present disclosure. The method 700 may be implemented by a device authentication computing device, such as device authentication computing device 300 of FIG. 3. The method 700 may be used to create, maintain, or update device information stored in a storage system such as storage system 500 of FIG. 5. Method 700 may occur separately from, consecutively with, or independently of method 600 depicted in FIG. 6. For example, in certain embodiments, a single comparison of device information may be used to both verify a transaction and determine whether stored device information requires modification or updating.

The device authentication computing device may receive transaction device information 702 of a consumer computing device and an identifier 703 as part of an online payment transaction. The device authentication computing device may then determine 704 whether a PAN data structure corresponding to the identifier is contained in the storage system. If a PAN does not exist, a registration process may be initiated in which the PAN is added to the storage system 706 and a Device corresponding to the user computing device is added to the PAN 708. As part of the registration process, the user of the consumer computing device may be verified by confirming personal information, providing a password, answering one or more security questions, and the like.

If a PAN exists, the device authentication computing device may loop through each Device of the PAN to determine if a cardholder computing device corresponding to the consumer computing device exists in the PAN. A counter may be initialized 710 to facilitate looping through each Device of the PAN. If the device authentication computing device determines 712 that the counter value is less than the total number of Device data structures in the PAN, the device authentication computing device may compare a CollectionID of the current Device with a CollectionID of the transaction device information obtained from the consumer computing device 714. A CollectionID is generally a hashed value representing the values of device information. In the case of a Device, the CollectionID is a hashed value of the device information stored in the Collection of the Device. The device authentication computing device, the merchant, or another party may perform a similar hashing operation to the transaction device information. By comparing the hashed transaction data to the CollectionID of the current Device, the device authentication computing device may quickly determine if the transaction device information is the same as the device information stored in the Collection of the current Device. If there is a match, the device authentication computing device may consider the device information in the Collection to be up to date 716 and no further actions are necessary to update the stored device information.

If the hashed value derived from the transaction device information does not match the CollectionID of the current Device, the device authentication computing device may then determine if high entropy transaction device information matches high entropy device information stored in the Collection of the current Device 718. If the device authentication computing device determines that the two sets of high entropy transaction device information match, the device authentication computing device may then compare medium entropy transaction device information to medium entropy device information stored in the Collection of the current Device 720 to determine whether the two sets of medium entropy device information match or differ in a predictable way. If the two sets of medium entropy device information match or predictably differ, the device authentication computing device may calculate a similarity score 724 for the current Device based on a comparison of one or more of high entropy device information, medium entropy device information, and low entropy transaction device information to similar entropy device information stored in the Collection of the current Device.

If the two sets of high entropy device information do not match or if the two sets of medium entropy device information do not match or differ unpredictably, the device authentication computing device may discard the current Device 722 as a potential match for the user computing device.

After the device authentication computing device discards a Device 722 or a similarity score is calculated 724, the device authentication computing device may increment the counter 726 such that the next Device of the PAN becomes the current Device. The device authentication computing device may then restart the comparison process described above using the new current Device. Specifically, the device authentication computing device may check the CollectionID of the new current Device with a hashed value of the transaction device information, and otherwise compare the transaction device information to the device information contained in the Collection of the new current Device.

If and when the counter exceeds the maximum number of Device data structures in the PAN 712 without the device authentication computing device finding a direct match for the user computing device, the device authentication computing device will have either discarded or assigned a similarity score to each Device of the PAN. The device authentication computing device may then determine which Device of the PAN has the highest similarity score 728. If the maximum similarity score exceeds a predetermined threshold 730, the Collection of the Device having the maximum similarity score may be updated to reflect the transaction device information. If, on the other hand, the maximum similarity score does not exceed the predetermined threshold, the Collection of the Device having the maximum similarity score is not updated 734.

### Additional Considerations

Computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “card,” “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads).

For example, one or more computer-readable storage media may include computer-executable instructions embodied thereon for authentication of online transactions. In this example, the computing device may include a memory device and a processor in communication with the memory device, and when executed by said processor, the computer-executable instructions may cause the processor to perform a method, such as the methods described and illustrated in the examples of FIGS. 6, 7A, and 7B.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example, the system is executed on a single computer system, without a connection to a server computer. In a further example, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. §112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A device authentication computing device, said device authentication computing device comprising one or more processors in communication with one or more memory devices, said device authentication computing device configured to:
receive cardholder device information for each of a plurality of cardholder computing devices of a cardholder;
store the cardholder device information based on a unique identifier associated with the cardholder;
receive an authentication request message requesting that a consumer computing device be authenticated as an authenticatable cardholder computing device;
receive, via an Internet browser of the consumer computing device, transaction device information corresponding to the consumer computing device;
receive a unique identifier associated with the cardholder;
retrieve the stored cardholder device information based on the unique identifier;
compare the stored cardholder device information with the transaction device information; and
transmit an authentication response message, either directly or indirectly, to the merchant, the authentication response message indicating whether the transaction device information matches the stored cardholder device information.

2. The device authentication computing device of claim 1, wherein comparing the stored cardholder device information with the transaction device information further comprises determining whether the stored cardholder device information matches the transaction device information beyond a predetermined match threshold.

3. The device authentication computing device of claim 1, wherein the transaction device information and the stored cardholder device information correspond to at least one of a browser engine name, a screen color depth, a system operating system, a system CPU, a system platform, a browser name, a browser engine version, a browser version, a user agent, an operating system, a platform, a screen width, a screen height, a system language, a time zone, a hypertext transfer protocol header, a browser language, an installed cookie, and an installed plugin.

4. The device authentication computing device of claim 1, wherein comparing the transaction device information and the stored device information further comprises at least one of: (i) matching a first hash value derived from the transaction device information to a second hash value derived from the stored device information; (ii) matching high entropy device information of the transaction device information to high entropy device information of the stored device information; (iii) matching medium entropy device information of the transaction device information to medium entropy device information of the stored device information; and (iv) matching low entropy device information of the transaction device information to low entropy device information of the stored device information.

5. The device authentication computing device of claim 1 further configured to transmit a transaction data request message configured to cause the consumer computing device to capture the transaction device information and to transmit the transaction device information to the device authentication computing device.

6. The device authentication computing device of claim 1 further configured to update at least a portion of the stored cardholder device information by replacing the portion of the stored cardholder device information with a corresponding portion of the transaction device information.

7. The device authentication computing device of claim 1, wherein the cardholder device information is received during a device registration process.

8. The device authentication computing device of claim 1 further configured to generate and transmit a fraud alert when the transaction device information does not match the stored cardholder device information beyond a predetermined match threshold.

9. The device authentication computing device of claim 1, wherein the authentication response message advises the merchant that the consumer computing device is one of the authenticated cardholder computing devices, and wherein said device authentication computing device is further configured to prompt a merchant computing device to complete a payment transaction associated with the authentication request message that was initiated by the cardholder using the one authenticated cardholder computing device.

10. A computer-implemented method for authenticating a user computing device during an online payment transaction, said method implemented using a device authentication computing device in communication with one or more memory devices, said method comprising:
receiving cardholder device information for each of a plurality of cardholder computing devices of a cardholder;
storing the cardholder device information based on a unique identifier associated with the cardholder;
receiving an authentication request message requesting that a consumer computing device be authenticated as an authenticatable cardholder computing device
receiving, via an Internet browser of the consumer computing device, transaction device information corresponding to the consumer computing device;
receiving a unique identifier associated with the cardholder;
retrieving the stored cardholder device information based on the unique identifier;
comparing the stored cardholder device information with the transaction device information; and
transmitting an authentication response message, either directly or indirectly, to the merchant, the authentication response message indicating whether the transaction device information matches the stored cardholder device information.

11. The method of claim 10 further comprising determining whether the stored cardholder device information matches the transaction device information beyond a predetermined match threshold.

12. The method of claim 10, wherein the transaction device information and the stored cardholder device information correspond to at least one of a browser engine name, a screen color depth, a system operating system, a system CPU, a system platform, a browser name, a browser engine version, a browser version, a user agent, an operating system, a platform, a screen width, a screen height, a system language, a time zone, a hypertext transfer protocol header, a browser language, an installed cookie, and an installed plugin.

13. The method of claim 10, wherein comparing the transaction device information and the stored device information further comprises at least one of: (i) matching a first hash value derived from the transaction device information to a second hash value derived from the stored device information; (ii) matching high entropy device information of the transaction device information to high entropy device information of the stored device information; (iii) matching medium entropy device information of the transaction device information to medium entropy device information of the stored device information; and (iv) matching low entropy device information of the transaction device information to low entropy device information of the stored device information.

14. The method of claim 10 further comprising updating at least a portion of the stored device information by replacing the portion of the stored device information with a corresponding portion of the transaction device information.

15. The method of claim 10, further comprising generating and transmitting a fraud alert when the transaction device information does not match the stored cardholder device information beyond a predetermined match threshold.

16. A computer-readable storage medium having computer-executable instructions embodied thereon, wherein when executed by a device authentication computing device having one or more processors in communication with one or more memory devices, the computer-executable instructions cause the device authentication computing device to:
receive cardholder device information for each of a plurality of cardholder computing devices of a cardholder;
store the cardholder device information based on a unique identifier associated with the cardholder;
receive an authentication request message requesting that a consumer computing device be authenticated as an authenticatable cardholder computing device
receive, via an Internet browser of the consumer computing device, transaction device information corresponding to the consumer computing device;
receive a unique identifier associated with the cardholder;
retrieve the stored cardholder device information based on the unique identifier;
compare the stored cardholder device information with the transaction device information; and
transmit an authentication response message, either directly or indirectly, to the merchant, the authentication response message indicating whether the transaction device information matches the stored cardholder device information.

17. The computer-readable storage medium of claim 16, wherein the computer-executable instructions cause the device authentication computing device to determine whether the stored cardholder device information matches the transaction device information beyond a predetermined match threshold.

18. The computer-readable storage medium of claim 16, wherein the transaction device information and the stored device information include at least one of a browser engine name, a screen color depth, a system operating system, a system CPU, a system platform, a browser name, a browser engine version, a browser version, a user agent, an operating system, a platform, a screen width, a screen height, a system language, a time zone, a hypertext transfer protocol header, a browser language, an installed cookie, and an installed plugin.

19. The computer-readable storage medium of claim 16, wherein the computer-executable instructions cause the device authentication computing device to compare the transaction device information to the stored device information by performing at least one: (i) matching a first hash value derived from the transaction device information to a second hash value derived from the stored device information;
(ii) matching high entropy device information of the transaction device information to high entropy device information of the stored device information; (iii) matching medium entropy device information of the transaction device information to medium entropy device information of the stored device information; and (iv) matching low entropy device information of the transaction device information to low entropy device information of the stored device information.

20. The computer-readable storage medium of claim 16, wherein the computer-executable instructions cause the device authentication computing device to calculate a similarity score representing a degree of similarity between the transaction device information and the stored device information corresponding to at least one of the plurality of cardholder computing devices.

21. The computer-readable storage medium of claim 16, wherein the computer-executable instructions cause the device authentication computing device to update at least a portion of the stored cardholder device information by replacing the portion of the stored cardholder device information with a corresponding portion of the transaction device information.
